(19) United States
(12) Patent Application Publication
(10) Pub. No.: US 2005/0108006 A1
(43) Pub. Date: May 19, 2005

(54) Method and device for determining the voice quality degradation of a signal

(75) Inventors: Charles-Henry Jurd, Colombes (FR); Houmad Tighezza, Colombes (FR); Abdelkrim Moulehiawy, Paris (FR)

Correspondence Address: SUGHRUE MION, PLLC, 2100 Pennsylvania Avenue, NW, Washington, DC, 20037-3213, US

(73) Assignee: ALCATEL

(21) Appl. No.: 10/178,299

(22) Filed: Jun. 25, 2002

(30) Foreign Application Priority Data
Jun. 25, 2001 (EP) 01 440 189.7

(51) Int. Cl. G10L 19/00

(52) U.S. Cl. 704/212

(57) ABSTRACT

The present invention concerns a method and a device for determining the voice quality degradation of a signal. Method for determining the voice or speech quality degradation of a signal, without using any reference or initial signal, wherein it mainly consists in decomposing the signal to be analysed by means of a segmentation algorithm, then applying at least one metric to the resulting decomposed signal and finally evaluating the signal degradation.

### TECHNICAL FIELD

The present invention is generally related to the transmission of signals through communication means, more particularly the transmission of voice or speech carrying signals, and concerns a method and a device for determining the voice or speech quality degradation of a signal transmitted over and/or through at least one communication device, network or similar.

The invention is based on a priority application EP 01 440 198.7 which is hereby incorporated by reference.

### BACKGROUND OF THE INVENTION

When a signal is transmitted over and through several devices and bearers, a degradation of the informative content of said signal occurs inevitably.

The importance of such degradation can depend on several factors such as length of the transmission, quality of the bearers and of the signal treatment devices, quality of the connexion and interfaces between the successive elements involved in the transmission procedure, possible interference or disturbance phenomena or similar.

Such degradation is particularly annoying when the concerned signals are speech or voice carrying signals.

It is therefore a necessity to measure the level of voice quality degradation in order to evaluate the considered transmission path and to be able to propose solutions to improve said level.

Tools to objectively measure the voice quality degradation do already exist, but they all need both of the source and the degraded signals to be able to perform the considered measurements.

This is in particular the case with the algorithm known as PQSM (for Perceptual Speech Quality Measurements) and corresponding to recommendation P.861 of the ITU (International Telecommunication Union), which is in fact dedicated to the estimatoin of the degradation due to vocal coder/decoder.

But such tools, while working in laboratory conditions, can generally not be applied practically, i.e. in real or field conditions, as both source and degraded signals are rarely available for the evaluation tool, in particular when network transmission is involved.

### SUMMARY OF THE INVENTION

Thus, the major aim of the invention is to propose a method and a device for objectively determining the degradation of the quality of a voice signal which needs only one signal.

Furthermore the proposed solution should be fully embeddable in existing systems, not too complex to implement and flexible in the ways of expressing the result of the degradation evaluation.

To that effect, the present invention concerns a method for determining the voice or speech quality degradation of a signal, without using any reference or initial signal, characterised in that it mainly consists in decomposing the signal to be analysed by means of a segmentation algorithm, then applying at least one metric to the resulting decomposed signal and finally evaluating the signal degradation.

The invention does also concern a device, mainly in the form of a software tool, which is able to carry out said method.

### BRIEF DESCRIPTIONS OF THE INVENTION

The present invention will be better understood thanks to the following description of an embodiment of said invention given as a non limitative example thereof, said description being made in relation with the enclosed drawings in which:

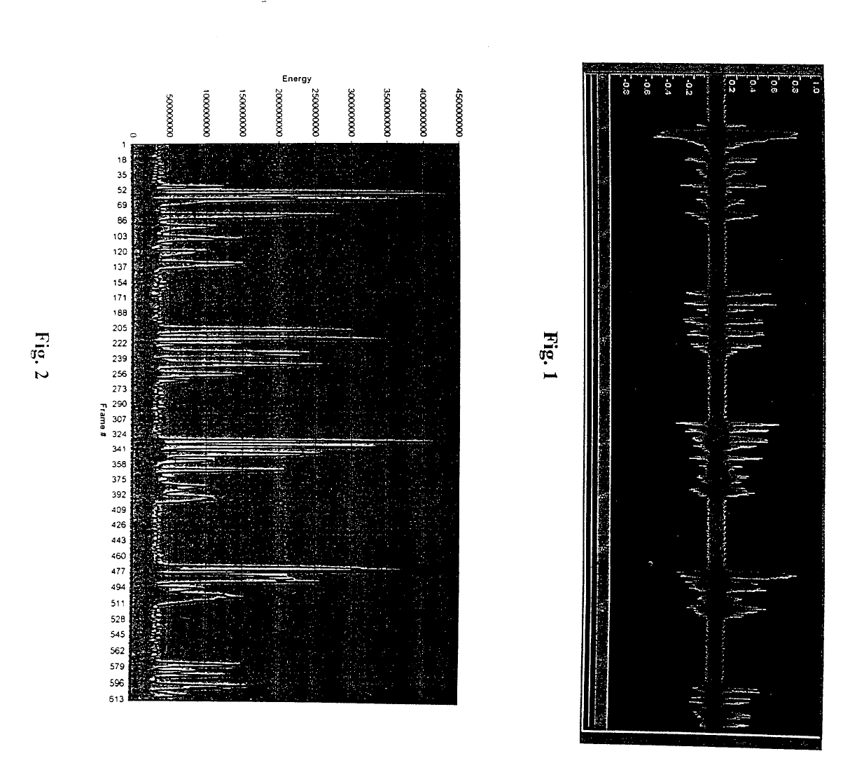

FIG. 1 represents a speech signal with annoying background noise

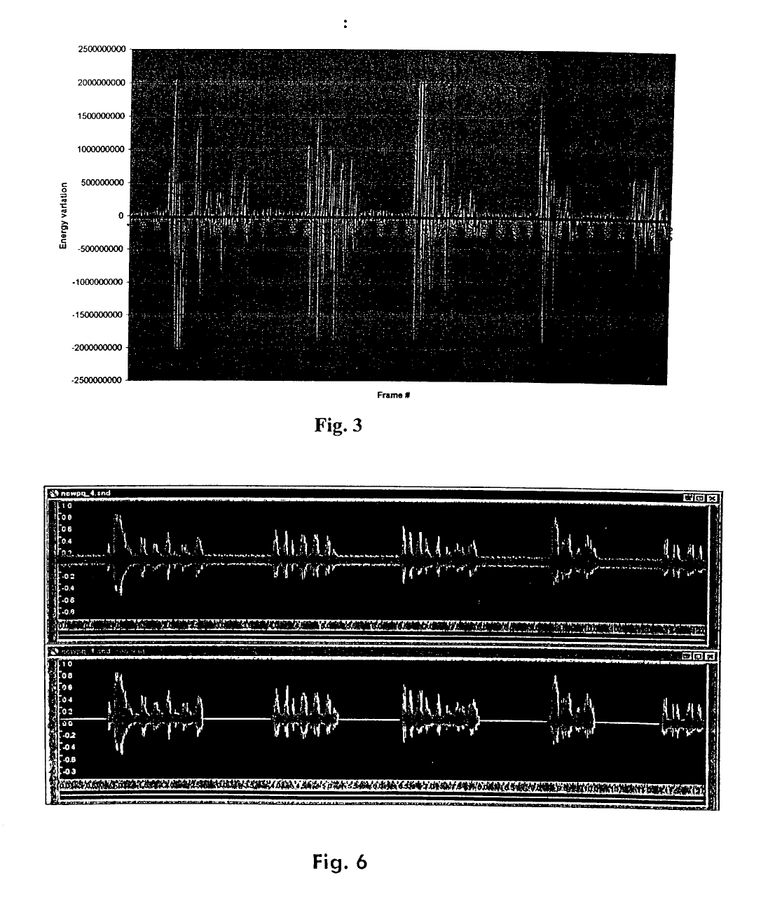

FIG. 2 is a graphical representation of the energy contained in the successive frames (groups of samples) of the signal of FIG. 1;

FIG. 3 is a graphical representation of the energy variation between the frames of the signal of FIGS. 1 and 2;

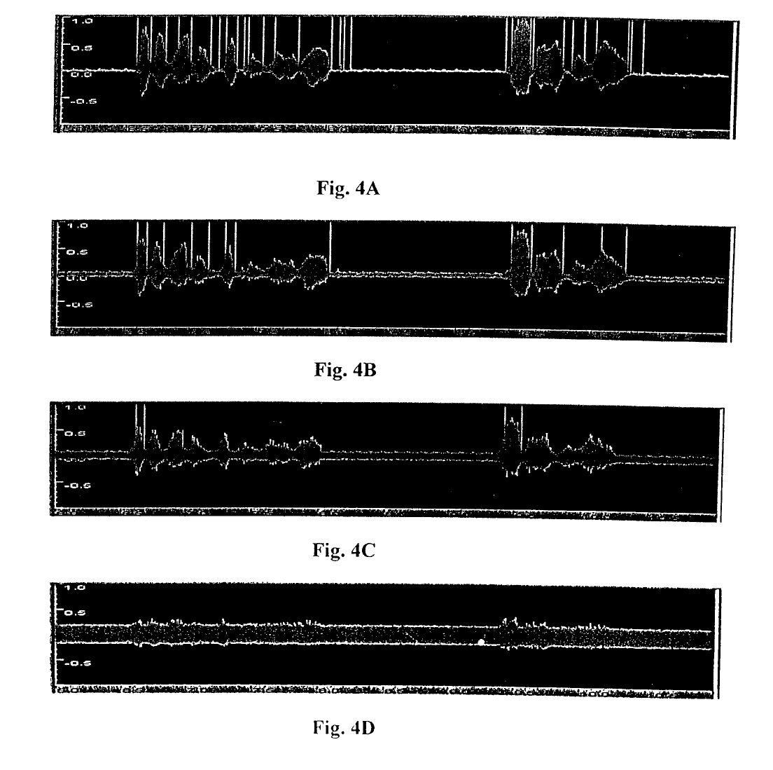

FIGS. 4A to 4D are graphical representations of signals subjected to a segmentation algorithm showing the variation of the quality of the segmentation in relation with the noise energy level

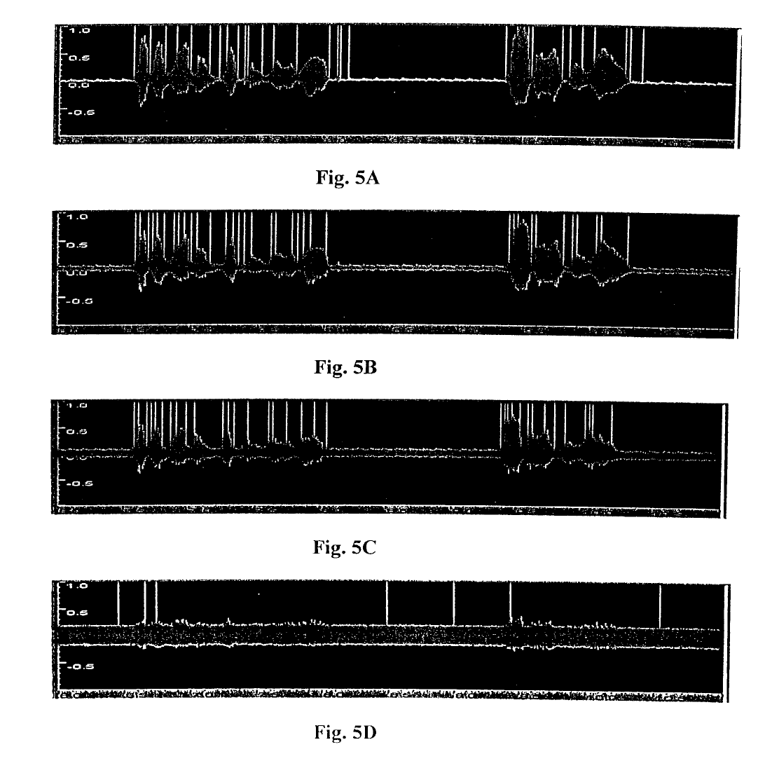

FIGS. 5A to 5D are graphical representations of the signals of FIG. 4 subjected to a segmentation algorithm with an automatically ajusted sensitivity according to the invention

FIG. 6 shows the signal of FIG. 1—before (upper part) and after (lower part) a segmentation procedure with noise extraction has been applied to it and,

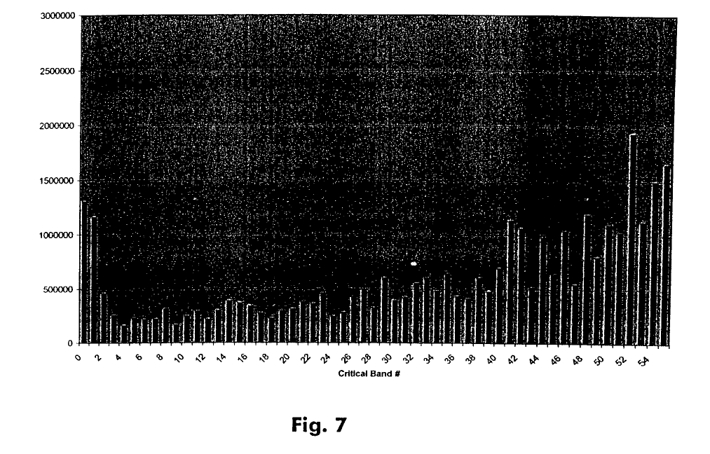

FIG. 7 is a graphical representation of the spectrum of the signal of FIGS. 1 and 6 (upper part) onto critical bands of Bark's scale.

### DETAILED DESCRIPTION OF PREFERRED EMBODIMENTS

According to the invention, the method for determining and measuring the degradation of the voice or speech component of a transmitted signal mainly consists in decomposing the signal to be analysed by means of a segmentation algorithm, then applying at least one metric to the resulting decomposed signal and finally evaluating the signal degradation.

The segmentation algorithm allows to precisely cut up the signal into homogeneous temporaly areas, sequences or segments, in which for example the envelope has a relatively constant behaviour, autorising a deeper local study of said signal.

Advantageously, the segmentation algorithm is based on the Burg's algorithm which provides a AR2 type model of the signal (see in particular “Musical Signal Parameter Estimation”, Tristan Jehan, PhD thesis, Berkeley Univ., URL: http://www.cnmat.berkeley.edu/tristan/report/report.html).

The resulting segmentation is representative of the type of information carried by the signal when the latter is only weakly noise infected (clear signal), i.e. a high density of segmentation points when the signal carries speech and a very low density of segmentation points or no segmentation points at all during the silence periods of the signal (periods with no speech).

Nevertheless, the more the signal is noise infected, the less the segmentation algorithm is precise and efficient. This loss of performance can be clearly seen by comparing mutually FIGS. 4A (clear signal) to 4D (heavily noisy signal).

The performance of said segmentation procedure can be enhanced by pretreating the signal to be analysed.

Thus, in accordance with the invention, the method can consist, before subjecting the signal to be analysed to the temporal segmentation algorithm, in sampling said signal, calculating energy related quantities for said signal samples (FIG. 2), thresholding said plurality of calculated quantities in order to identify the speech, silence and/or noise sequences or periods of said signal, and determining the average energy level of noise during the sequences or periods of the signal carrying no speech or silence sequences or periods, in order to perform a first signal degradation evaluation.

The previous operation can consist in obtaining a PCM (Pulse Code Modulation) version of the signal and submitting said sampled signal, as successive groups or frames of samples, to a G.729 type coder in order to determine the groups or frames of samples, and the associated periods or sequences of the signal, comprising speech or voice activity.

Nevertheless, the energy related quantities preferably correspond to the square numbers of the values of the samples and to the sums of these square numbers for all samples of predetermined groups or frames of samples.

As the simple thresholding of the energy related quantities of the sample groups does not allow to distinguish the groups or frames carrying speech, the invention advantageously consists, in order to discriminate sequences or periods with and without speech of the signal, in determining the variation of the energy related quantities within or between predetermined or consecutive groups of samples, spotting the sequences in which or between which the variation is of a small magnitude and identifying as sequences or periods of silence or without speech, sequences or periods which correspond to at least two consecutive groups of samples with small internal and/or mutual variation of the energy related quantities.

Indeed, it has been noticed by the inventors that the energy differences between groups or frames are important when said signal contains speech and that the energy differences between groups or frames are small or null and relatively constant when said signal contains noise or silence (see FIG. 3).

By applying a threshold to this metric (energy variation between frames) it is easily possible to identify on the one hand the speech and on the other hand the noise or silence frames.

Then by calculating the average energy level of noise during said identified noise or silence frames, one can operate a first evaluation of the sound quality of the signal and allocate a first mark.

It should also be noted that real noise or silence frames are never isolated, but always exist as series of such frames. Therefore an isolated frame identified as silence or noise frame is very likely not a real noise or silence frame and should be disregarded as an erroneous detection.

The pretreatment operation described herebefore can thus be used to submit to the segmentation algorithm a signal comprising only speech frames.

According to a preferred embodiment of the invention, the method consists in using a variable triggering threshold for the temporal segmentation algorithm, in the form of a quantity which is dependent from the current average value of energy or of an energy related quantity of the noise carried within said signal.

The use of such an automatically adaptive threshold (which can be infinitely variable in the theoretical range of the signal) allows to provide a constant segmentation efficiency independently of the level of noise of said signal (see FIGS. 5A to 5D).

In order to obtain a more precise view of the degradation which occurred to the signal, the inventive method further consists in performing a spectral analysis of the various homogeneous sequences or periods resulting from the decomposition of the signal to be analysed by the segmentation algorithm, said sequences or periods corresponding to one or several predetermined group(s) or frame(s) of samples extracted from the signal to be analysed (FIG. 6).

According to a preferred feature of the invention, the said spectral analysis mainly consists in subjecting the groups of samples to a fast Fourier transform, then in projecting the spectrum onto critical bands of the Bark's scale and eventually analysing the resulting data.

Such a projection of a signal from a Hertz scale into a Bark scale, which provides a psycho-accoustic representation of the signal, is in particular described in “Bark and ERB Bilinear Transforms”, Julius O. Smith III et al., IEEE Transactions on Speech and Audio Processing, pp. 697-708, November 1999 (see FIG. 7).

Practically, said spectral analysis is advantageously at least partly performed by applying a PSQM type algorithm to the consecutive groups of samples forming the signal, said algorithm carrying out the fast Fourier transform and the spectral projection.

Said spectral analysis normally comprises two different types of treatment procedures depending on whether the considered group of samples to be analysed incorporates speech or not, and therefore has been identified as such by the combined previous operative steps of segmentation/voice activity detection.

Thus, the inventive method consists, for the groups of samples corresponding to sequences or periods comprising speech, and after performing the fast Fourier transform and projecting the resulting spectrum onto the bands of the Bark's scale, in calculating for each group an energy ratio SNR defined as: SNR=Energy (in concerned bands)/Energy (outside concerned bands), wherein the concerned bands correspond to the bands in which speech activity can be detected, preferably bands 14 to 41 of the 56 critical bands of the Bark's scale.

Said SNR (Signal to Noise Ratio) provides a good estimation of the voice degradation and can be used as a quality mark.

Alternatively, said method consists, for the groups of samples corresponding to sequences or periods of the signal without speech, i.e. silence or noise sequences, in averaging the spectral features of the signal in order to caracterise the existing noise and deduct its origin.

The present invention also concerns a device for determining the noise or speech quality degradation of a signal, without using any reference or initial signal, characterised in that said device mainly comprises means for decomposing the signal to be analysed through a segmentation algorithm, means for applying at least one metric to the resulting decomposed signal and means for evaluating the signal degradation.

Advantageously, said device also comprises additional means for identifying the speech, silence and/or noise sequences or periods of the signal to be analysed and for determining the average energy level of noise during the sequences or periods of the signal without speech activity.

1. Method for determining the voice or speech quality degradation of a signal, without using any reference or initial signal, said method comprising the steps of: decomposing the signal to be analysed by means of a segmentation algorithm, then applying at least one metric to the resulting decomposed signal and finally evaluating the signal degradation, while before subjecting the signal to be analysed to the temporal segmentation algorithm, sampling said signal, calculating energy related quantities for said signal samples, thresholding said plurality of calculated quantities in order to identify the speech, silence and/or noise sequences or periods of said signal, and determining the average energy level of noise during the sequences or periods of the signal carrying no speech or silence sequences or periods, in order to perform a first signal degradation evaluation.

2. Method according to claim 1, wherein the segmentation algorithm is based on the Burg's algorithm which provides a AR2 type model of the signal.

3. Method according to claim 1, wherein it consists, in order to discriminate sequences or periods with and without speech of the signal, of determining the variation of the energy related quantities within or between predetermined or consecutive groups of samples, spotting the sequences in which or between which the variation is of a small magnitude and identifying as sequences or periods of silence or without speech, sequences or periods which correspond to at least two consecutive groups of samples with small internal and/or mutual variation of the energy related quantities.

4. Method according to anyone of claims 1 to 4, wherein obtaining a PCM version of the signal and submitting said sampled signal, as successive groups or frames of samples, to a G.729 type coder in order to determine the groups or frames of samples, and the associated periods or sequences of the signal, comprising speech or voice activity.

5. Method according to anyone of claims 1 to 4, wherein using a variable triggering threshold for the temporal segmentation algorithm, in the form of a quantity which is dependant from the current average value of energy or of an energy related quantity of the noise carried within said signal.

6. Method according to anyone of claims 1 to 5, wherein performing a spectral analysis of the various homogeneous sequences or periods resulting from the decomposition of the signal to be analysed by the segmentation algorithm, said sequences or periods corresponding to one or several predetermined group(s) or frame(s) of samples extracted from the signal to be analysed.

7. Method according to claim 6, wherein the spectral analysis mainly consists in subjecting the groups of samples to a fast Fourier transform, then in projecting the spectrum onto critical bands of the Bark's scale and eventually analysing the resulting data.

8. Method according to claim 7, wherein the spectral analysis is at least partly performed by applying a PSQM type algorithm to the consecutive groups of samples forming the signal, said algorithm carrying out the fast Fourier transform and the spectral projection.

9. Method according to claim 7 or 8, wherein for the groups of samples corresponding to sequences or periods comprising speech, and after performing the fast Fourier transform and projecting the resulting spectrum onto the bands of the Bark's scale, in calculating for each group an energy ratio SNR defined as: SNR=Energy (in concerned bands)/Energy (outside concerned bands), wherein the concerned bands correspond to the bands in which speech activity can be detected, preferably bands 14 to 41 of the 56 critical bands of the Bark's scale.

10. Method according to claim 7 or 8, wherein for the groups of samples corresponding to sequences or periods of the signal without speech, i.e. silence or noise sequences, in averaging the spectral features of the signal in order to caracterise the existing noise and deduct its origin.

11. Device for determining the noise or speech quality degradation of a signal, without using any reference or initial signal, whereby said device mainly comprises means for decomposing the signal to be analysed through a segmentation algorithm, means for applying at least one metric to the resulting decomposed signal and means for evaluating the signal degradation.

12. Device according to claim 11, whereby it also comprises additional means for identifying the speech, silence and/or noise sequences or periods of the signal to be analysed and for determining the average energy level of noise during the sequences or periods of the signal without speech activity.

13. Device according to claims 11 and 12, whereby said means are adapted to perform the method according to any of claims 1 to 10.
